(19) United States
(12) Patent Application Publication
(10) Pub. No.: US 2014/0292056 A1
(43) Pub. Date: Oct. 2, 2014

(54) HEAD RESTRAINT FOR A VEHICLE SEAT AND METHOD FOR PRODUCING SAID HEAD RESTRAINT

(71) Applicants: Jan-Hendrik Peters, Wuppertal (DE); Lars Hennig, Leichlingen (DE); Reiner Pietrus, Speyer (DE); Martin Gottwald, Leverkusen (DE)

(72) Inventors: Jan-Hendrik Peters, Wuppertal (DE); Lars Hennig, Leichlingen (DE); Reiner Pietrus, Speyer (DE); Martin Gottwald, Leverkusen (DE)

(73) Assignee: Johnson Controls Technology Company

(21) Appl. No.: 14/130,791

(22) PCT Filed: Jul. 3, 2012
(86) PCT No.: PCT/EP2012/062929

§ 371 Date: Mar. 27, 2014

(30) Foreign Application Priority Data
Jul. 5, 2011 (DE) 10 2011 106 857.4

(51) Int. Cl. B60N 2/48

(52) U.S. Cl. CPC B60N 2/4805; B60N 2/4802
USPC 297/391; 29/428

(57) ABSTRACT

A head restraint for a vehicle seat has a holding element whih, in the fitted state, is fastenable to a backrest of the vehicle seat. A support element for holding a pad formed from a foamed material is fastened to the holding element. The support element is formed from a repeatedly bent and/or folded material.

The invention relates to a head restraint for a vehicle seat, having a retaining element which, in the fitted state, can be fastened on a backrest of the vehicle seat, wherein a carrier element for retaining a pad formed from a foam material is fastened on the retaining element.

The invention also relates to a method for producing a head restraint for a vehicle seat, having a retaining element which, in the fitted state, is fastened on a backrest of the vehicle seat, wherein a carrier element for retaining a pad formed from a foam material is fastened on the retaining element.

It is generally known for head restraints, for reinforcing purposes, to be provided with an insert which is fastened on head-restraint rods and is covered by foamed plastic. For this purpose, generally a material which forms the surface of the head restraint, for example leather or fabric, is introduced into a mold, which is then filled with the liquid plastic (in-situ method). The plastic cures in the mold.

US 2008/0100116 A1 discloses a head-restraint arrangement for a vehicle seat, wherein the head-restraint arrangement comprises a retaining element with two spaced-apart rod elements for arranging and for retaining the head-restraint arrangement on a backrest of the vehicle seat. The head-restraint arrangement also comprises a pad which is formed from a foam material and at least partially encloses the retaining element in an upper region. Also provided is a strap which is formed from plastic, extends between the two rod elements, in the upper region of the retaining element, is likewise enclosed by the pad and serves as a carrier element for the pad. In order to produce the head restraint, the retaining element is arranged, together with the strap, in a mold. The mold is then filled with the foam material, which forms the pad.

Furthermore, DE 198 40 728 A1 discloses a head restraint having a carrier structure and a padding arrangement supported by the carrier structure and formed from a foam. The carrier structure has a folding-bellows-like energy absorber which, on a front side, has a supporting surface for the padding arrangement and, on a rear side, acts on a dimensionally stable abutment. The energy absorber contains natural fibers and thermoplastic material. The padding arrangement completely covers the folding-bellows-like energy absorber.

It is an object of the invention to specify a head restraint with improved reinforcement in relation to the prior art and also a method which is intended for producing such a head restraint and is improved in relation to the prior art.

The object is achieved according to the invention, in respect of the head restraint, by the features specified in claim 1 and, in respect of the method, by the features specified in claim 11.

The head restraint for a vehicle seat comprises a retaining element which, in the fitted state, can be fastened on a backrest of the vehicle seat, wherein a carrier element for retaining a pad formed from a foam material is fastened on the retaining element. According to the invention, the carrier element is formed from a material which is bent and/or folded a number of times.

Such a bent and/or folded carrier element allows simple fitting, and requires only a small amount of installation space, and forms an optimum carrier for the foam material, formed in particular from plastic, during the foam-filling and curing operations (in-situ method). In particular in a fully folded-together state of the carrier element, the carrier element is in the form of a very small transporting unit, and therefore the carrier element has a very small transporting volume. This means that the carrier element is suitable for very space-saving storage and transportation, for example from a site at which the carrier element is produced to a processing site, at which the head restraint is to be produced. Such a head restraint, with a carrier element which can be fastened in a flexible manner on the retaining element and is intended for accommodating, and for retaining, the foamed plastic, has sufficiently good levels of stiffness and strength.

According to a development of the head restraint according to the invention, the material is folded and/or bent a number of times in a z-shaped manner. This configuration of the material allows the carrier element to be compressed particularly simply for fitting purposes, and it can therefore be introduced even into extremely small installation spaces. Furthermore, the material which is folded and/or bent a number of times in a z-shaped manner can easily be pushed onto two rod elements of the retaining element, particularly simple fitting being made possible as a result. In addition, the z-shaped bending and/or folding, as already mentioned, allows a very small transporting volume, and the carrier element can be introduced into extremely small installation spaces in order to form the head restraint.

In a further configuration, the material has a Shore hardness of less than 50 Shore A. This further simplifies the operation of compressing the carrier element. In particular, this makes it possible to have a thin foam thickness for forming the head restraint, i.e. all that is required is for the carrier element to be encapsulated in a small amount of foam material, since the low level of hardness of the carrier element means that there is no need for the foam material to provide a thick padding arrangement. This makes it possible for the carrier element to be installed, and encapsulated in the foam material, in extremely small installation spaces.

In a development, the material comprises a paper product, for example in the form of paperboard and/or cardboard, and/or felt and/or a woven fabric which has one or more layers and, in one possible configuration, comprises inserts made of plastic for stabilizing purposes. Such materials can be processed particularly simply, and with low levels of outlay, and are available cost-effectively. In addition, these materials likewise make it possible for the carrier element to be simply compressed to form a folded arrangement for transportation and fitting purposes.

In particular the material, or the material in conjunction with the foam material, is flame-retardant and/or fire-retardant, and therefore fires in the vehicle are avoided or at least the spread of fires is prevented, or at least delayed.

According to a further configuration, the carrier element has pores and/or openings, which have the foam material passing through them. This ensures an optimum grip of the pad formed from the foam material. Furthermore, a distribution of the foam material is optimized.

According to a development of the head restraint, the retaining element comprises two rod elements, wherein the carrier element is arranged between the two rod elements. This arrangement allows, on the one hand, a secure grip of the head restraint on the backrest and, on the other hand, a high level of force absorption on the part of the head restraint for supporting or restraining the head.

For a secure grip and optimum positioning of the carrier element on the rod elements, the carrier element, according to a further configuration, has two parallel first through-openings, for example perforations, which run through all the upwardly sloping and downwardly sloping walls of the carrier element and through which the rod elements are guided. The possibility of such an arrangement of the carrier element is promoted further by it being of folded and soft form. Upwardly sloping and downwardly sloping walls of the carrier element are understood here to mean those portions which, on account of the bending and/or folding, slope up from a low point or slope down from a high point. With the material folded, such walls are those upwardly sloping and planar regions which run at a defined angle in relation to one another, generally also referred to as folds.

Furthermore, according to a possible development, the carrier element has two parallel second through-openings, which run through a plurality of upwardly sloping and downwardly sloping walls of the carrier element and through which in each case at least one thread element is guided and is fastened such that it is possible to adjust an extent of the carrier element along the retaining element. This arrangement allows controlled and defined adjustment of the extent, i.e. controlled and defined expansion and delimitation, of the carrier element. It is thus possible in a particularly advantageous manner for the extent of the carrier element to be adjusted individually once the carrier element has been fitted on the retaining element, and this therefore means that an optimum arrangement and extent is always achieved for the carrier element.

In the method for producing a head restraint for a vehicle seat, having a retaining element which, in the fitted state, is fastened on a backrest of the vehicle seat, a carrier element for retaining a pad formed from a foam material is fastened on the retaining element.

According to the invention, a material is folded and/or bent a number of times in order to produce the carrier element.

The method according to the invention makes it possible, in a simple manner, to produce a head restraint with a bent and/or folded carrier element which is easy to fit, requires only a small amount of installation space and forms an optimum carrier for the foam material during the foam-filling and curing operations. A head restraint with sufficiently good levels of stiffness and strength is produced here.

In order to make it possible for the carrier element to be compressed particularly simply to form a folded arrangement for transportation and for fitting purposes, in which case said folded arrangement can be introduced even into extremely small installation spaces during the fitting operation, the material, in a development of the method, is folded and/or bent a number of times in a z-shaped manner.

In order also to allow a secure grip and optimum positioning of the carrier element on the rod elements, in one possible configuration, the carrier element has introduced into it two parallel first through-openings, which run through all the upwardly sloping and downwardly sloping walls of the carrier element, wherein two rod elements of the retaining element are guided through the through-openings such that the carrier element is arranged between the two rod elements.

In a development of the method, the carrier element has introduced into it two parallel second through-openings, which run through a plurality of upwardly sloping and downwardly sloping walls of the carrier element and through which in each case at least one thread element is guided and fastened. In particular, the in each case at least one thread element is used to adjust an extent of the carrier element along the retaining element. It is thus possible to adjust the extent of the carrier element in a controlled and defined manner.

According to an advantageous configuration, the carrier element, for sufficient levels of strength and stiffness, is enclosed by a plastic, in particular encapsulated in foam or by injection molding. In addition, the carrier element may be provided with pores and/or small openings. These may be, for example, significantly smaller than the through-openings for guiding through the rod elements; however, they may also be, for example, of equal size or larger. These pores and/or openings allow, on the one hand, an optimum grip of the pad, formed preferably from the foam material, and, on the other hand, an optimum foaming process.

Exemplary embodiments of the invention will be explained in more detail hereinbelow with reference to drawings, in which:

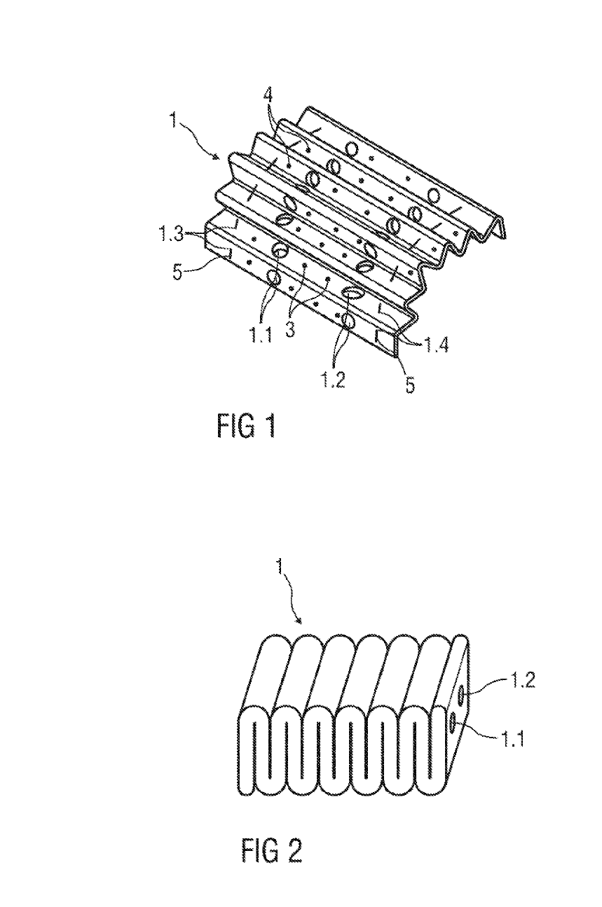

FIG. 1 shows, schematically, a carrier element for arranging on a retaining element of a head restraint for a vehicle seat,

FIG. 2 shows, schematically, a carrier element in a folded-together transporting state, and

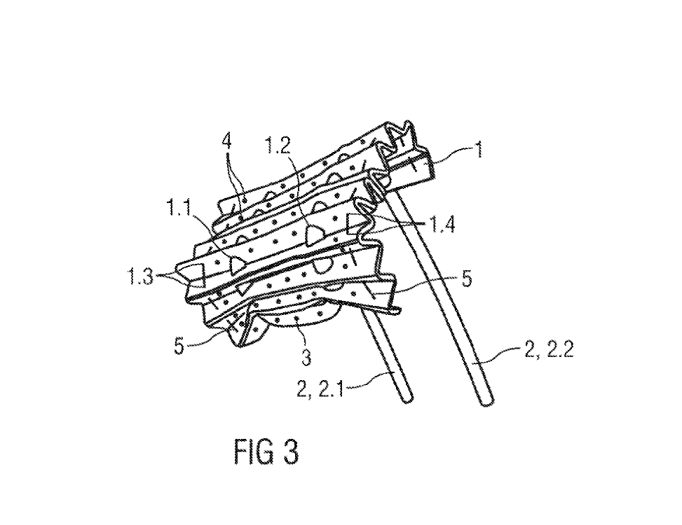

FIG. 3 shows, schematically, a retaining element with a carrier element arranged thereon.

Corresponding parts are provided with the same designations in all figures.

FIG. 1 illustrates a carrier element 1 for a head restraint for a vehicle seat. FIG. 2 shows the carrier element in a folded-together transporting state. FIG. 3 shows the carrier element 1 arranged on a retaining element 2 which, in the fitted state, can be fastened on a backrest of the vehicle seat. Exemplary embodiments of the invention will be explained together hereinbelow with reference to FIGS. 1 to 3.

The carrier element 1 is folded from a soft foldable material. For example, the carrier element 1 is formed from a soft material with a Shore hardness of less than 50 Shore A. In particular, the carrier element 1 is formed from a felt material, from a paper product, for example paperboard, or from a woven fabric which has one or more layers and inserts made of plastic. The material here is preferably flame-retardant and fire-retardant. Furthermore, the carrier element 1 is folded in a z-shaped manner and can be contracted or extended in the manner of an accordion. This design of the carrier element 1 means that, in a fully folded-together state, as illustrated in FIG. 2, it is in the form of a very small and particularly compact transporting unit, and therefore the carrier element 1 has a very small transporting volume. This means that the carrier element is suitable for very space-saving storage and transportation, for example from a site at which the carrier element 1 is produced to a processing site, at which the head restraint can be produced.

The retaining element 2 comprises two rod elements 2.1, 2.2, which are bent at least at one end. The other, opposite straight end of the rod elements 2.1, 2.2 can be arranged in a displaceable manner in the backrest of the vehicle seat. As illustrated, the retaining element 2 is formed from a u-shaped tube portion with a round cross section, the vertical rod elements 2.1, 2.2 of which allow the head restraint to be adjusted in height.

In order to fasten the carrier element 1 on the retaining element 2, the carrier element 1 comprises two parallel through-openings 1.1, 1.2, e.g. perforations, which run through all the folds and through which the rod elements 2.1, 2.2 are guided.

For sufficient levels of strength and stiffness, the carrier element 1 is preferably enclosed by a plastic, in particular encapsulated in foam or by injection molding. A pad is formed as a result.

In addition, the carrier element 1 has pores 3 and small openings 4 which, in the example illustrated, are significantly smaller than the through-openings 1.1, 1.2. This provides for an optimum foaming process and an optimum grip for the foam material used, the latter passing through the pores 3 and openings 4.

In addition, the carrier element 1 also has, parallel to the through-openings 1.1, 1.2 through which the rod elements 2.1, 2.2 are guided, smaller through-openings 1.3, 1.4, through which one or more thread elements 5 are drawn and are fastened such that controlled and defined widening and thus mounting of the folded carrier element 1 along the retaining element 2 and along the rod elements 2.1, 2.2 are possible.

This means that the carrier element 1, in the folded state illustrated in FIG. 2, can be pushed particularly simply onto the rod elements 2.1, 2.2 since, in this state, the first through-openings 1.1, 1.2 are arranged directly one behind the other, and therefore the rod elements 2.1, 2.2 can be inserted into the through-openings 1.1, 1.2. This also allows the carrier element 1 to be drawn over small radii of the rod elements 2.1, 2.2. Thereafter, the carrier element 1 can be widened, and thus mounted along the rod elements 2.1, 2.2, in a controlled and defined manner by means of the thread elements 5. This widening by means of the thread elements 5 also makes it possible in particular for the carrier element 1 to be positioned in a defined manner on the rod elements 2.1, 2.2 in a foaming tool, in order for it to be encased in the foam material during the foaming process. The narrow and soft material of the carrier element 1 here allows a thin foam-material layer and therefore, in the state in which it is encased in the foam material, it requires only a small amount of installation space.

A carrier element 1 folded in such a manner allows fitting which is thus simple and requires only a small amount of installation space, both in the folded state, for transportation purposes, and in the non-folded state, sheathed in foam material, in the head restraint. In particular it is made possible for the folded carrier element 1 to be particularly simply widened or mounted or compressed or drawn together, and it can therefore be introduced into extremely small installation spaces for fitting purposes.

As an alternative, or in addition, the material of the carrier element 1 can be bent in a manner which has not been illustrated specifically or can be folded in some other manner. Bending is, for example, in the form of a sine curve. Folding can take place, for example, in the form of a rectangle function.

### LIST OF DESIGNATIONS

1 Carrier element
1.1, 1.2 First through-openings
1.3, 1.4 Second through-openings
2 Retaining element
2.1, 2.2 Rod element
3 Pores
4 Openings
5 Thread element

1. A head restraint for a vehicle seat, comprising:
a retaining element which, in a fitted state, can be fastened on a backrest of the vehicle seat; and
a carrier element for retaining a pad formed from a foam material, wherein the carrier element is fastened on the retaining element and the carrier element is formed from a material which is at least one of folded and bent a number of times.

2. The head restraint as claimed in claim 1, wherein the material is at least one of folded and bent a number of times in a z-shaped manner.

3. The head restraint as claimed in claim 1, wherein the material has a Shore hardness of less than 50 Shore A.

4. The head restraint as claimed in claim 1, wherein the material comprises felt and/or a woven fabric with one or more layers and/or a paper product.

5. The head restraint as claimed in claim 4, wherein the woven fabric comprises inserts made of plastic.

6. The head restraint as claimed in claim 1, wherein the material itself, or in conjunction with the foam material, is at least one of flame-retardant and fire-retardant.

7. The head restraint as claimed in claim 1, wherein the carrier element has at least one of pores and openings, which have the foam material passing through them.

8. The head restraint as claimed in claim 1, wherein the retaining element comprises two rod elements, wherein the carrier element is arranged between the two rod elements 11.

9. The head restraint as claimed in claim 8, wherein the carrier element has two parallel first through-openings, which run through all the upwardly sloping and downwardly sloping walls of the carrier element and through which the rod elements are guided.

10. The head restraint as claimed in claim 9, wherein the carrier element HUM has two parallel second through-openings, which run through a plurality of upwardly sloping and downwardly sloping walls of the carrier element and through which in each case at least one thread element is guided and is fastened such that it is possible to adjust an extent of the carrier element along the retaining element.

11. A method for producing a head restraint for a vehicle seat, having a retaining element which, in the fitted state, is fastened on a backrest of the vehicle seat, the method comprising:
at least one of folding and bending a material a number of times to produce a carrier element for retaining a pad formed from a foam material;
fastening the carrier element on the retaining element.

12. The method as claimed in claim 11, wherein the material is at least one of folded and bent a number of times in a z-shaped manner.

13. The method as claimed in claim 11, comprising introducing into the carrier element two parallel first through-openings, which run through all the upwardly sloping and downwardly sloping walls of the carrier element, wherein two rod elements of the retaining element are guided through the first through-openings such that the carrier element is arranged between the two rod elements.

14. The method as claimed in claim 13, comprising introducing into the carrier element two parallel second through-openings, which run through a plurality of upwardly sloping and downwardly sloping walls of the carrier element and through which in each case at least one thread element is guided and fastened.

15. The method as claimed in claim 14, wherein the in each case at least one thread element is used to adjust an extent of the carrier element along the retaining element.
